(19) United States
(12) Patent Application Publication
(10) Pub. No.: US 2010/0007700 A1
(43) Pub. Date: Jan. 14, 2010

(54) ARRANGEMENT FOR EXCHANGING INK PRINTING MODULES

(76) Inventor: Wolfgang Muhl, Hohen Neuendorf (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/481,710

(22) Filed: Jun. 10, 2009

(30) Foreign Application Priority Data
Jul. 14, 2008 (DE) 10 2008 033 052.3

(51) Int. Cl. B41J 2/14

(52) U.S. Cl. 347/49

(57) ABSTRACT

An arrangement for exchanging ink printing modules in a postage meter machine and/or addressing machine, has a shaft-shaped receptacle with a lock for said modules. A complication-free exchanging of the ink printing module that functions with a low technical outlay, and without contamination and mechanical impairment of the counter-contacts for the ink printing module, by the use of counter-contacts, to a contact field and to a module chip of ink printing module that are adjustably situated in the receptacle by means of a bar. When the ink printing module is unlocked, the counter-contacts are distanced therefrom.

### BACKGROUND OF THE INVENTION

1. Field of the Invention

The present invention relates to an arrangement for exchanging ink printing modules, or ink printing cartridges, in a printing device, in particular in a postage meter machine and/or addressing machine.

2. Description of the Prior Art

It has proved useful to exploit the advantages of ink printing in the area of machine postage metering and/or addressing. Here the printing takes place in contactless fashion using an ink printing head; see for example DE 44 24 771 C1, corresponding to U.S. Pat. No. 6,367,911 and EP 0 696 509 B1, corresponding to U.S. Pat. No. 6,390,577.

When commercially available ink printing heads are used for office printers, these heads are usually a component of an ink printing module; i.e., the ink printing head and cartridge form a unit.

In office printers, the ink printing module is situated in a shaft-shaped receptacle in a positively guided, lockable manner. When the ink has been consumed, the ink printing module has to be exchanged. In order to do this, it is withdrawn manually. For this purpose, first a locking lever is released and the ink printing module is grasped with two fingers at a grip corner, and is drawn out obliquely past the locking lever; see for example the user handbook for HP DeskJet 1220C, October 1999. Here, the skill and care exercised by the operator more or less determine whether, during the exchanging of the ink printing module, the counter-contacts thereof are damaged by friction and/or contaminated by residual ink.

In contrast to the space conditions in office printers, accessibility to the ink printing modules in postage meter machines is significantly more limited, so that exchanging the modules is even more difficult.

A postage meter machine having a printing system that has two ink printing modules as well as an appertaining cleaning and sealing device is described in DE 10 2005 052 150.9, corresponding to United States Patent Application Publication No. 2007/0097173.

This printing system is composed of a frame, two ink printing modules, and a shaft-type receptacle having two compartments allocated to the modules.

Each ink printing module is composed of an ink printing head including ink supply, a chip, and a contact field. The counter-contacts are fixedly attached in the receptacle in mating fashion.

The ink printing modules are situated parallel but offset to one another, in order to achieve the required print gap length.

The receptacle is mounted so as to be pivotable about an axle that is fastened in the frame. For priming, as well as for the sealing of the ink printing head, the receptacle is pivoted out of the printing position into a position in which the nozzle surface of the printing head is oriented downward. At the same time, this is the position in which an exchanging of the ink printing module is possible.

The printing position and the sealing position are accordingly determined by unambiguously defined positions of the ink printing head and of the cleaning and sealing device.

In addition, various cleaning areas are provided. In a cleaning area in front of the sealing position, the ink printing head is pivoted out of the printing position far enough that the nozzle surface is situated in the area of engagement of the wiping lips of the cleaning and sealing device. During the wiping process, the wiping lips pass both over the nozzle surface and along two side edges, causing residual ink deposits on said edges. During the withdrawal of the ink printing module, these deposits can contaminate the counter-contacts, accordingly endangering the functional reliability of the printing device.

This effect is amplified if the printing device is provided with an additional ink supply system, because in this case significantly more wiping operations, and thus more deposits, occur.

Another problem is that during the withdrawal or insertion of the ink printing module, the mentioned edge may unfavorably grind along the counter-contacts, which may damage the contacts.

In order to avoid the aforementioned disadvantages, an arrangement has been proposed for exchanging ink printing modules in a postage meter and/or addressing machine of this type; see DE 10 2006 034 611.4, corresponding to United States Patent Application Publication No. 2008/0018705 in which means are provided in the receptacle in the form of draw hooks for withdrawal and means are provided on the ink printing module in the form of guide webs on the chip holder; means are also provided in the receptacle in the form of a spring pin and a spring piece for decontacting the ink printing module, these parts being mechanically coupled to one another in such a way that decontacting takes place already before the withdrawal process has been initiated, and that moreover a strip-off device is situated in the pivot area of the rear edge of the nozzle surface. The technical outlay for this device is considerable.

### SUMMARY OF THE INVENTION

An object of the present invention is to improve the functional reliability and to increase the life span of the print device with minimal outlay.

More specifically, an object of the present invention is to provide an arrangement for complication-free exchanging of an ink printing module in a printing device having the design of the type described above, that functions with a low technical outlay and is also suitable for postage meter and/or addressing machines. In particular, contamination and mechanical damage to the counter-contacts of the ink printing module are to be prevented.

The above object is achieved in accordance with the present invention by an arrangement for exchanging ink printing modules in a printing device having a shaft-shaped receptacle having a locking mechanism for the ink printing module, formed by an ink printing head and an ink supply, that includes a contact field and a module chip on a narrow side of the module, and a nozzle surface on the adjacent end face of the module, and having corresponding counter-contacts in the receptacle. In accordance with the invention, the counter-contacts are adjustably mounted and are mechanically coupled to a pivotable bar of the locking mechanism. The mounting and the coupling are configured to cause the counter-contacts, simultaneously with unlocking of the locking mechanism, to be spaced from the module and, upon locking of the locking mechanism, to cause the counter-contacts to be placed in contact with the contact field and with the module chip.

### BRIEF DESCRIPTION OF THE DRAWINGS

FIG. 1 is a perspective view of the printing system in a postage meter machine with opened service flap, viewed from the front right, having a receptacle for two print modules.

FIG. 2 is a perspective view of the receptacle from the front right, with inserted and locked print modules.

FIG. 3 is a perspective view of a print module from the rear left.

FIG. 4 is a perspective view, from the front right, of the receptacle with inserted and locked printing module, and with an empty, unlocked compartment, in a partially exploded view, with details of the locking and unlocking mechanism.

FIG. 5 is an exploded view of the receptacle without printing modules from the front left.

FIG. 6 is a view of the receptacle with partially withdrawn printing module from the right, in partial section, showing details of the decontacting.

FIG. 7 is a view from the right of the receptacle with inserted and locked printing module, in partial section.

### DESCRIPTION OF THE PREFERRED EMBODIMENTS

For simplification and for easier understanding, the figures are partially schematic. As an abbreviation, hereinafter the term “printing module” is used in place of “ink printing module.”

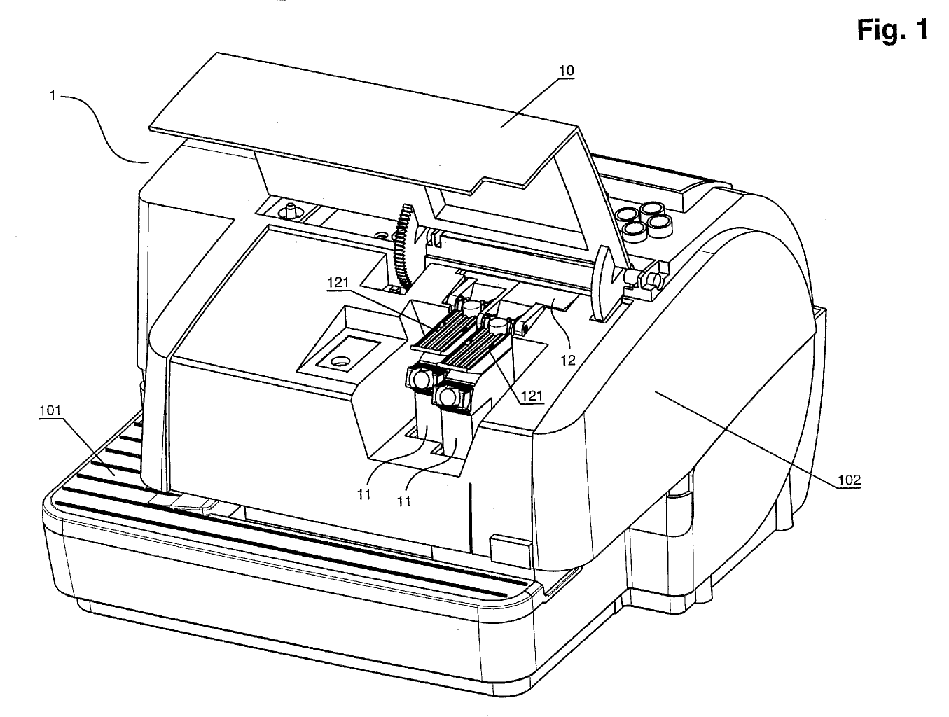

In FIG. 1, in the cover wall of a postage meter machine housing 1 a service flap is provided that extends into the area of the guide plate 101 for the print substrate. Service flap 10 is shown in the open state, so that receptacle 12 with its two print modules 11 is visible. Print modules 11 are fully inserted and are each fixed in place by an allocated bar 121. Cover 102 is used to prevent unauthorized access to the postage meter machine. The space under this cover can be used for additional ink tanks.

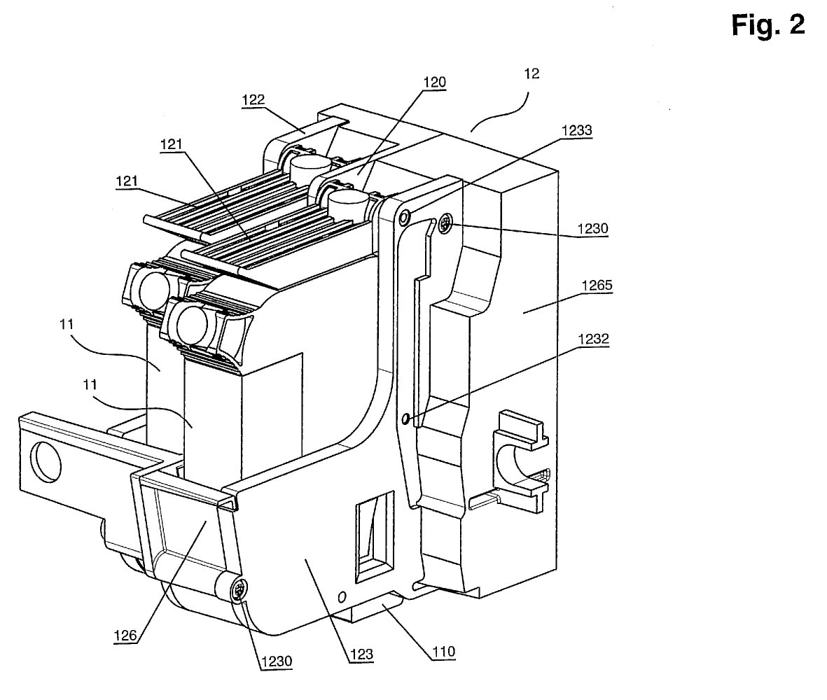

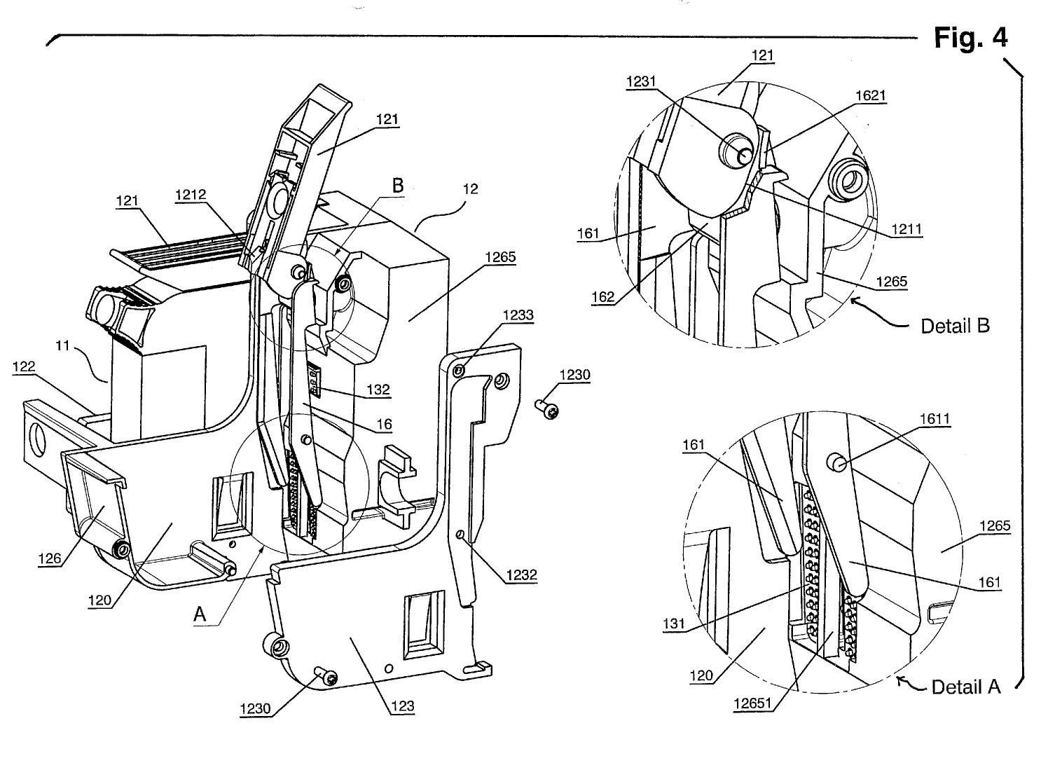

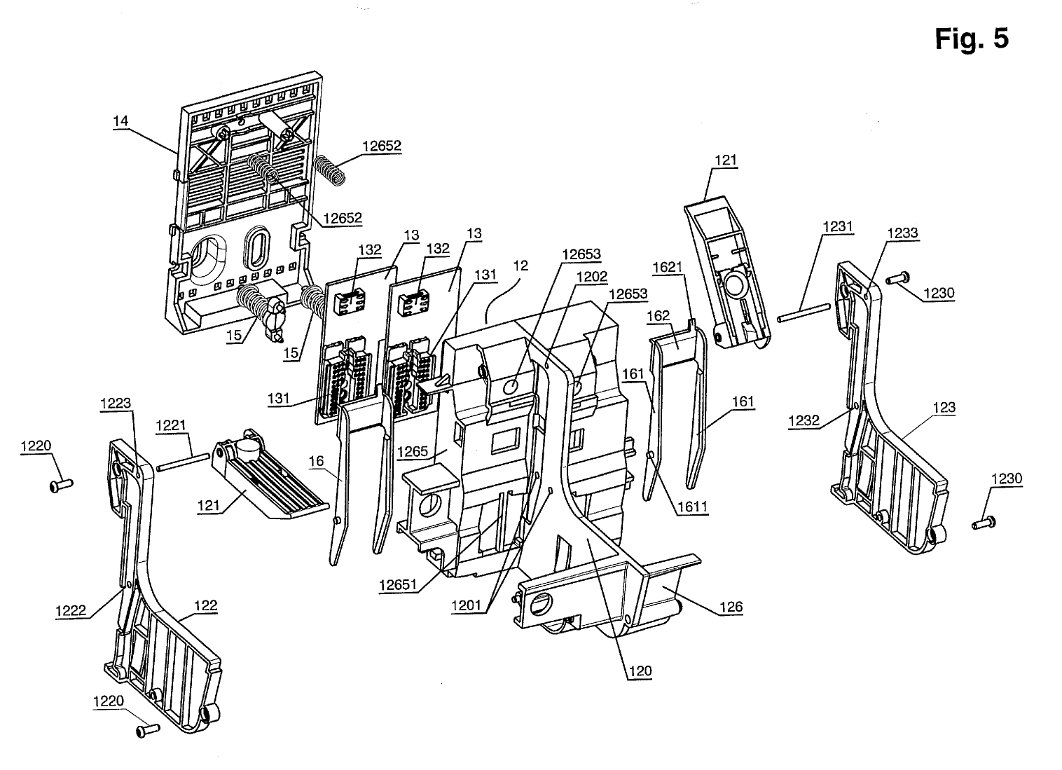

FIG. 2 shows a receptacle 12 with two locked printing modules 11. In the lowermost region of printing module 11, ink printing head 110 is located. Receptacle 12 is made up of two side walls 122, 123 and a common double-angled bearer 126 whose fixed component is a center wall 120. In this way, two chambers are formed for the reception of the printing modules 11; see also FIGS. 4 and 5. Side walls 122, 123 have the same construction, so that further description can be limited to right side wall 123. Bar 121 can be pivoted about an axle 1231 (see FIG. 4, detail B); a bore 1233 is provided in side wall 123 for this axle. Another bore 1232 acts as a guide hole for a pivot pin 1611; see also FIGS. 4 and 5. Side wall 123 is detachably fastened to bearer 126 by two fastening screws 1230. Analogously, bar 121 is mounted in the left chamber so as to be capable of pivoting about an axle 1221, for which a bore 1202 is provided in center wall 120 and a bore 1223 is provided in left side wall 122. The fastening takes place by means of screws 1220.

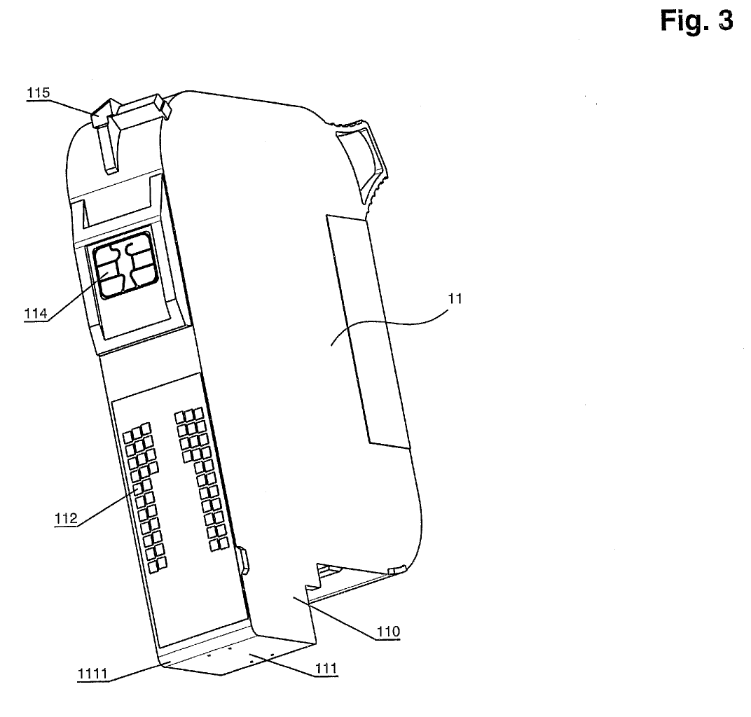

According to FIG. 3, a commercially available printing module 11 contains in its lower part an ink printing head 110, having on its floor a nozzle surface 111 with rounded-off rear edge 1111. In the area of ink printing head 110, on the rear side of printing module 11 there is situated contact field 112 in the form of two angles arranged mirror-symmetrically to one another at a distance from one another. On the rounded upper rear edge of printing module 11, a locking nose 115 is integrally formed in a known manner, which is matched to the contour of bar 121. In the front upper part, a grip part (not designated in more detail) is provided. Module chip 114 is situated above contact field 112.

In FIG. 4, right side wall 123 has been cut away, bar 121 for right printing module 11 is folded up, and said module has been removed. On the folded-up bar 121, integrally formed shoulder 1212 can be seen as the counterpiece to locking nose 115; see also FIG. 3. Bar 121 for left printing module 11 is closed. Bar 121 is realized in a known manner as a two-armed lever that is mounted so as to be capable of rotation about an axle 1231; see detail B. The longer, front lever arm is fashioned as a grip part. The outer contour of the shorter, rear lever arm acts as a guide edge 1211 for a fork-shaped rocker 16. Rocker 16 is mounted with its longitudinal limbs 161 in mating recesses of side walls 122, 123, and of center wall 120, so as to be pivotable about an integrally formed pivot pin 1611. For pivot pin 1611, mating guide hole 1201 is provided in center wall 120, mating guide hole 1222 is provided in left side wall 122, and mating guide hole 1232 is provided in right side wall 123; see also FIG. 5. Cross-limb 162 of rocker 16 is provided with a guide nose 1621 that is situated in the engagement area of guide edge 1211 of bar 121. When bar 121 is pressed down (locked state of printing module 11), cross-limb 162 is pivoted toward bearer rear wall 1265. Correspondingly, the away-facing lever arm of longitudinal limb 161 is pivoted away from bearer rear wall 1265; see also detail A. When bar 121 is folded up, these relations are reversed.

In rear wall 1265 of bearer 126, in the lower area counterpieces 131 to contact field 112 of printing module 11 are sunk-in in flexibly adjustable fashion; above this, a counter piece 132 is also flexibly sunk in for contacting module chip 114 of printing module 11; see also FIG. 5. Between counter pieces 131, bearer rear wall 1265 has a web 12651 that is fixedly perpendicularly situated and that acts as a stop for printing module 11, in particular for the contact-free part of contact field 112 in the unlocked state; see detail A. In this way, it is ensured that printing module 11 can be removed from shaft-shaped receptacle 12, or introduced into this receptacle, in such a way that undesired contactings are reliably prevented between the contacts of printing module 11 and counter-contacts 131, 132. The contacting does not take place until bar 121 is closed.

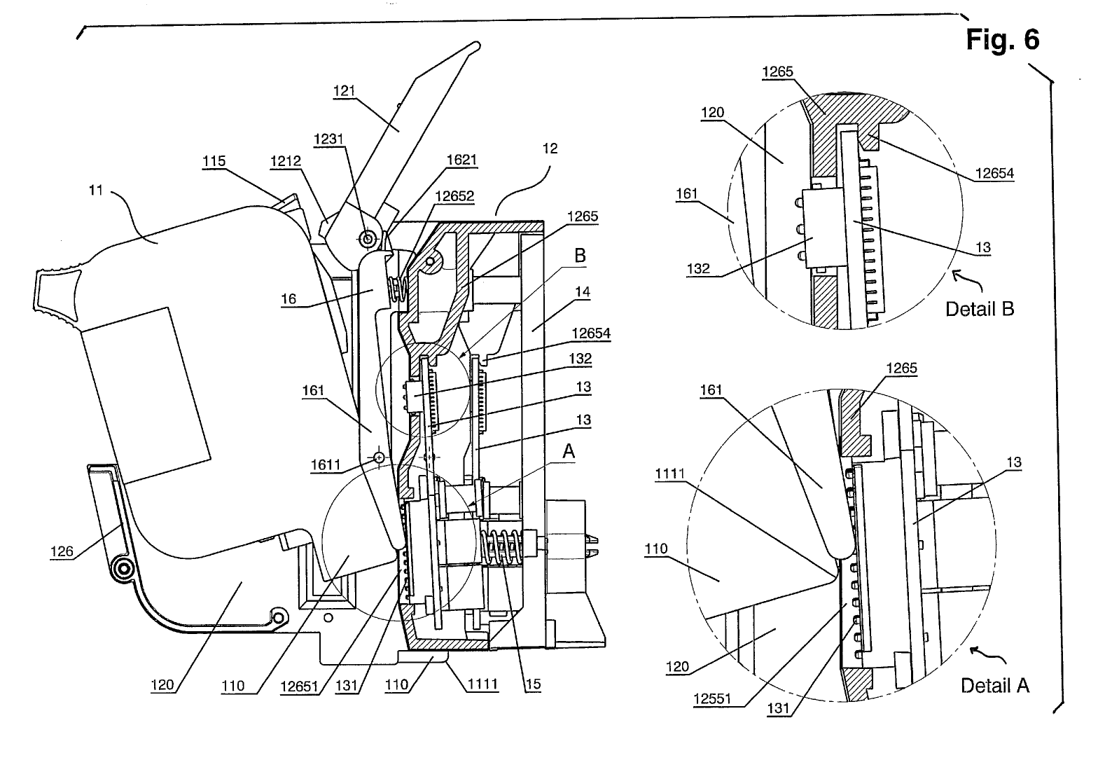

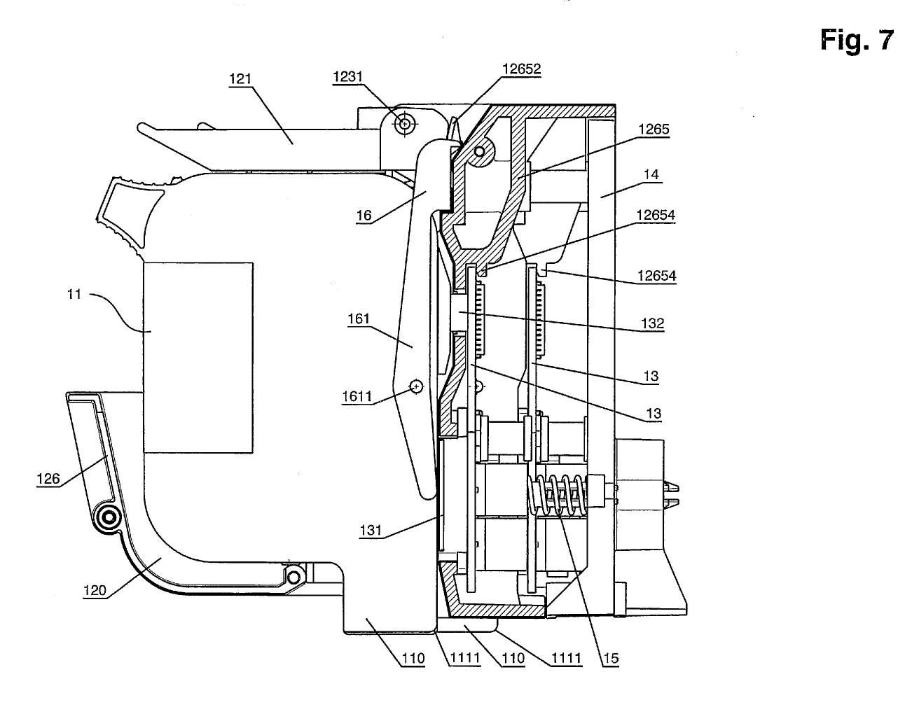

FIG. 5 shows further details of receptacle 12, of board [or: circuit board] 13, of a locking plate 14, of a spring pressure piece 15, and of rocker 16. Installation of rocker 16 is possible only if side walls 122, 123 have been removed; the same holds for bar 121. Board 13 can be placed into mating recesses in bearer rear wall 1265; see also FIGS. 6 and 7.

Between board 13 and locking plate 14, in the contact area there is situated a spring pressure piece 15 with a pre-tensioned pressure spring that is fixed on the one hand in board 13 and on the other hand in locking plate 14. Spring pressure piece 15 is dimensioned such that sufficient contact force is ensured.

Pressure spring 12652 is situated between locking plate 14 and cross-limb 162 of rocker 16, and extends through a through-bore 12653 in bearer rear wall 1265. Pressure spring 12652 is used to reset or pivot back board 13. The pivot point is here situated in a mated recess of bearer rear wall 1265; see also FIG. 6, detail B, as well as FIG. 7. The upper edge of board 13 lies against a correspondingly shaped (rounded-off) support web 12654. The dimensions of rocker 16, including its appertaining pressure spring 12652, are selected such that the counterforce is greater than the contacting force.

FIG. 6 shows the situation in which bar 121 is released and printing module 11 is partially withdrawn. Under the spring action of pressure spring 12652 on rocker 16, board 13 is pivoted back.

FIG. 7 shows the situation in which printing module 11 is fully inserted and bar 121 is fully pressed down. Board 13 lies flat against the allocated areas of bearer rearwall 1265.

Although modifications and changes may be suggested by those skilled in the art, it is the intention of the inventor to embody within the patent warranted hereon all changes and modifications as reasonably and properly come within the scope of his contribution to the art.

I claim as my invention:

1. An arrangement for exchanging an ink printing module in a printing device, said ink printing module comprising a module housing containing an ink printing head and an ink supply, said module having a narrow side at which an electrical contact field and a module chip are located, and an adjacent end face at which a nozzle surface of the imprinting head is located, said arrangement comprising:
a shaft-shaped receptacle configured to receive said ink printing module therein;
a locking mechanism operable by a bar that is pivotably mounted to said receptacle to lock said ink printing module in said receptacle upon closure of said bar on said receptacle and to unlock said module from said receptacle upon opening of said bar relative to said receptacle; and
a plurality of counter-contacts adjustably mounted in said receptacle and mechanically coupled to said bar with a mechanical coupling configured to separate said counter-contacts from said imprinting module upon opening of said bar to unlock said printing module and to move said counter-contacts into contact with said contact field and with said module chip simultaneously upon closure of said bar to lock said module in said receptacle.

2. An arrangement as claimed in claim 1 wherein said mechanical coupling comprises a board on which the counter-contacts are mounted, said board being flexibly and pivotably mounted to a supporting rear wall of said receptacle.

3. An arrangement as claimed in claim 2 wherein said recess comprises sidewalls with vertical recesses therein and a center wall, and wherein said mechanical coupling comprises a fork-shaped rocker pivotable around pivot pins on longitudinal arms thereof that engage said vertical recesses, and having a cross-arm carrying, with a non-positive fit, a pressure spring that is supported at an opposite side on a locking plate of said rear wall of said receptacle.

4. An arrangement as claimed in claim 3 comprising a guide nose integrally formed on said cross-arm of said rocker, and situated in an area of engagement of a guide edge of said bar, said bar being operable as a two-armed lever.

5. An arrangement as claimed in claim 4 wherein said bar is mounted to said receptacle for pivoting around an axel, and has a front longer lever arm formed as a gripper, and a rear, shorter lever arm formed with an exterior contour forming said guide edge for said rocker.

6. An arrangement as claimed in claim 3 comprising a spring pressure element located between said board and said locking plate, said spring pressure element having a pre-tensioned pressure spring that produces a contacting force that urges said counter-contacts against said contact field and said module chip, said rocker and said pressure spring being dimensioned and configured to produce a counterforce that is greater than said contacting force.
